(19) United States
(12) Patent Application Publication
(10) Pub. No.: US 2006/0176960 A1
(43) Pub. Date: Aug. 10, 2006

(54) Method and system for decoding variable length code (VLC) in a microprocessor

(76) Inventors: Paul Lu, Los Altos, CA (US); Weiping Pan, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 11/053,214

(22) Filed: Feb. 7, 2005

(51) Int. Cl. H04N 11/04

(52) U.S. Cl. 375/240.23

(57) ABSTRACT

Methods and systems for processing video data are provided herein and may comprise receiving an input encoded bitstream to be processed. A portion of the received input encoded bitstream may be matched against stored indexed variable length code entries having a corresponding video information entry. If a match is found, the matched portion may be removed from the input encoded bitstream. The matching and/or the removing may be offloaded to at least one on-chip coprocessor. The coprocessor may comprise a table look-up (TLU) module with a plurality of on-chip memories, such as RAM, and may be adapted to store one or more entries from a VLC encoding/decoding table. For example, an on-chip memory may be utilized to store a VLC code entry and another on-chip memory may be utilized to store the corresponding VLC code entry attributes that each code may represent, such as LAST, RUN, and LEVEL entries.

### CROSS-REFERENCE TO RELATED APPLICATIONS/INCORPORATION BY REFERENCE

This application is related to the following applications:

U.S. patent application Ser. No. ______ (Attorney Docket No. 16036US01), filed Feb. 7, 2005, and entitled “Method And System For Image Processing In A Microprocessor For Portable Video Communication Devices”;

U.S. patent application Ser. No. ______ (Attorney Docket No. 16094US01), filed Feb. 7, 2005, and entitled “Method And System For Encoding Variable Length Code (VLC) In A Microprocessor”;

U.S. patent application Ser. No. ______ (Attorney Docket No. 16099US01), filed Feb. 7, 2005, and entitled “Method And System For Video Compression And Decompression (CODEC) In A Microprocessor”; and

U.S. patent application Ser. No. ______ (Attorney Docket No. 16232US02), filed Feb. 7, 2005, and entitled “Method And System For Video Motion Processing In A Microprocessor.”

The above stated patent applications are hereby incorporated herein by reference in their entirety.

### BACKGROUND OF THE INVENTION

Video compression and decompression techniques, as well as different image size standards, are utilized by conventional video processing systems, such as portable video communication devices, during recording, transmission, storage, and playback of video information. For example, quarter common intermediate format (QCIF) may be utilized for playback and recording of video information, such as videoconferencing, utilizing portable video communication devices, for example, portable video telephone devices. The QCIF format is an option provided by the ITU-T's H.261 standard for videoconferencing codes. It produces a color image of 144 non-interlaced luminance lines, each containing 176 pixels to be sent at a certain frame rate, for example, 15 frames per second (fps). QCIF provides approximately one quarter the resolution of the common intermediate format (CIF) with resolution of 288 luminance (Y) lines each containing 352 pixels.

In addition, common intermediate format (CIF) and video graphics array (VGA) format may be utilized for high quality playback and recording of video information, such as camcorder. The CIF format is also an option provided by the ITU-T's H.261/P×64 standard. It may produce a color image of 288 non-interlaced luminance lines, each containing 352 pixels to be sent at a certain frame rate, for example, 30 frames per second (fps). The VGA format supports a resolution of 640×480 pixels and is the most common display size used in the PC world.

Conventional video processing systems for portable video communication devices, such as video processing systems implementing the QCIF, CIF, and/or VGA formats, may utilize video encoding and decoding techniques to compress video information during transmission, or for storage, and to decompress elementary video data prior to communicating the video data to a display. The video compression and decompression (CODEC) techniques, such as variable length coding (VLC), in conventional video processing systems for portable video communication devices utilize a significant part of the computing resources of a general purpose central processing unit (CPU) of a microprocessor, or other embedded processor, for processing and transferring video data during encoding and/or decoding. The general purpose CPU, however, handles other real-time processing tasks, such as communication with other modules within a video processing network during a video teleconference utilizing the portable video communication devices, for example. The increased amount of computation-intensive video processing tasks and data transfer tasks executed by the CPU and/or other processor, in a conventional QCIF, CIF, and/or VGA video processing system results in a significant decrease in the video quality that the CPU or processor can provide for the video processing network.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for processing video data, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary VLC video decoding system that may be utilized in connection with an aspect of the invention.

FIG. 2 is a block diagram of the exemplary microprocessor architecture for video compression and decompression utilizing a coprocessor, in accordance with an embodiment of the invention.

FIG. 3 is a block diagram of an exemplary coprocessor for variable length code (VLC) processing, in accordance with an embodiment of the invention.

FIG. 4 is a block diagram of a table look-up (TLU) module within a coprocessor for VLC processing, in accordance with an embodiment of the invention.

FIG. 5 is a block diagram of a bitstream handler (BSH) module within a coprocessor for VLC processing, in accordance with an embodiment of the invention.

FIG. 6 is a block diagram of a table look-up (TLU) module utilized for VLC decoding, in accordance with an embodiment of the invention.

FIG. 7 is a block diagram of a table look-up (TLU) module utilized for VLC decoding with multiple definition tables, in accordance with an embodiment of the invention.

FIG. 8 is a flow diagram of an exemplary method for VLC decoding, in accordance with an embodiment of the invention.

### DETAILED DESCRIPTION OF THE INVENTION

Certain aspects of the invention may be found in a method and system for processing video data. Aspects of the method may comprise receiving an input encoded bitstream to be processed. A portion of the received input encoded bitstream may be matched against stored indexed variable length code entries having a corresponding video information entry. If a match is found, the matched portion may be removed from the input encoded bitstream. The matching and/or the removing may be offloaded to at least one on-chip coprocessor. The coprocessor may comprise a table look-up (TLU) module with a plurality of on-chip memories, such as RAM, and may be adapted to store one or more entries from a VLC encoding/decoding table. For example, an on-chip memory may be utilized to store a VLC code entry and another on-chip memory may be utilized to store the corresponding VLC code entry attributes that each code may represent, such as LAST, RUN, and LEVEL entries. In addition, a bitstream handler (BSH) module may also be utilized within the coprocessor to manage generation of the encoded bitstream during encoding, and/or to extract consecutive bits from the encoded bitstream during decoding.

U.S. application Ser. No. ______ (Attorney Docket No. 16094US01) filed on even date herewith discloses a method and system for encoding variable length code (VLC) in a microprocessor and is hereby incorporated herein by reference in its entirety.

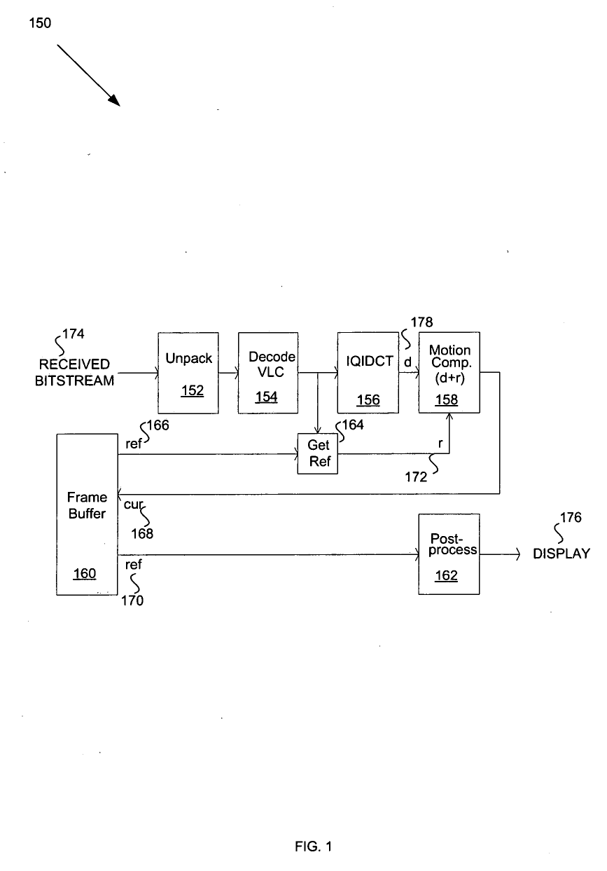

FIG. 1 is a block diagram of an exemplary VLC video decoding system that may be utilized in connection with an aspect of the invention. Referring to FIG. 1, the VLC video decoding system 150 may comprise a bitstream unpacker 152, a VLC decoder 154, a motion reference acquiring module 164, a frame buffer 160, an inverse quantizer and inverse discrete cosine transformer (IQIDCT) module 156, a motion compensator 158, and a post-processor 162.

The bitstream unpacker 152 and the VLC decoder 154 may comprise suitable circuitry, logic, and/or code and may be adapted to decode an elementary video bitstream and generate video information like the motion reference and/or the corresponding quantized frequency coefficients for the prediction error of each macroblock. The IQIDCT module 156 comprises suitable circuitry, logic, and/or code and may be adapted to transform one or more quantized frequency coefficients to one or more prediction errors. The motion compensator 158 comprises suitable circuitry, logic, and/or code and may be adapted to acquire a prediction error and its motion reference to reconstruct a current macroblock. In one aspect of the invention, to increase the processing efficiency within the video decoding system 150, the VLC decoder 154 may be implemented in a coprocessor utilizing one or more memory modules to store VLC code and/or corresponding attributes. The coprocessor may also comprise a bitstream handler (BSH) module, which may be utilized to manage extracting bits from the bitstream for VLC matching during decoding. In addition, the BSH module may be implemented as a tightly coupled extension of a central processor within the VLC video decoding system.

In operation, the unpacker 152 and the VLC decoder 154 may decode an elementary video bitstream 174 and generate various video information, such as the motion reference and the corresponding quantized frequency coefficients of each macroblock. The generated motion reference may then be communicated to the reference acquiring module 164 and the IQIDCT module 156. The reference acquiring module 164 may acquire pixels of the motion reference 166 from the frame buffer 160 and may generate a reference macroblock 172 corresponding to the quantized frequency coefficients. The reference macroblock 172 may be communicated to the motion compensator 158 for macroblock reconstruction.

The IQIDCT module 156 may transform the quantized frequency coefficients to one or more prediction errors 178. The prediction errors 178 may be communicated to the motion compensator 158. The motion compensator 158 may then reconstruct a current macroblock 168 utilizing the prediction errors 178 and its motion reference 172. The reconstructed current macroblock 168 may be stored in the frame buffer 160 as the reference for a subsequent frame and/or for displaying. The reconstructed frame 170 may be communicated from the frame buffer 160 to the post-processor 162 in a line-by-line sequence for displaying. The post-processor 162 may convert the YUV-formatted line from frame 170 to an RGB format and communicate the converted line to the display 176 to be displayed in a desired video format.

Referring to FIG. 1, in one aspect of the invention, one or more on-chip accelerators may be utilized to offload computation-intensive tasks from the CPU during decoding of video data. For example, one accelerator may be utilized to handle motion related computations, such as motion estimation, motion separation, and/or motion compensation. A second accelerator may be utilized to handle computation-intensive processing associated with discrete cosine transformation, quantization, inverse discrete cosine transformation, and inverse quantization. Another on-chip accelerator may be utilized to handle post-processing the decoded YUV data to RGB format for displaying. Furthermore, one or more on-chip memory (OCM) modules may be utilized to improve the time required to access data in the external memory during video data decoding. For example, an OCM module may be utilized for storing QCIF-formatted video data and for buffering one or more video frames that may be utilized during decoding. In addition, the OCM module may also comprise buffers for storing intermediate computational results during decoding, such as discrete cosine transformation (DCT) coefficients and/or prediction error information.

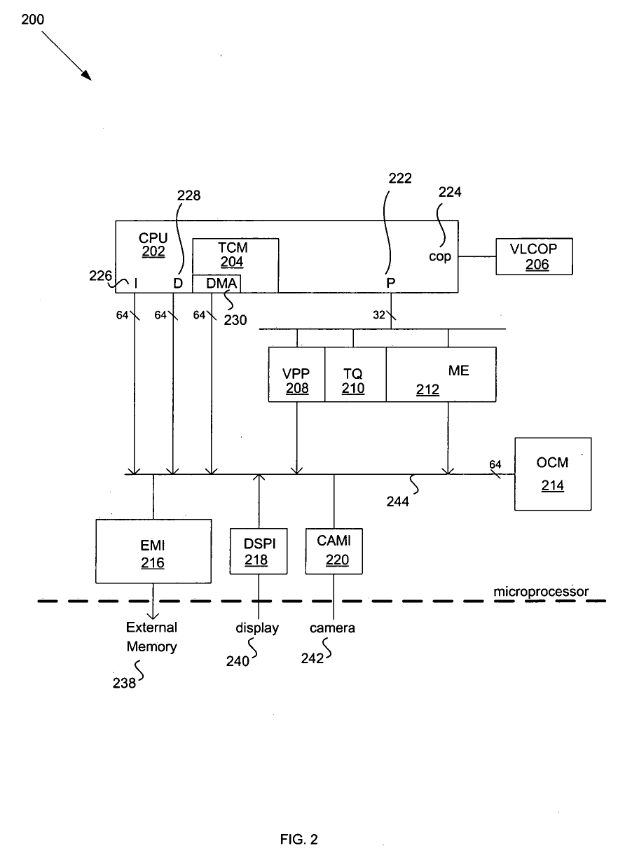

FIG. 2 is a block diagram of the exemplary microprocessor architecture for video compression and decompression utilizing a coprocessor, in accordance with an embodiment of the invention. Referring to FIG. 2, the exemplary microprocessor architecture 200 may comprise a central processing unit (CPU) 202, a variable length code coprocessor (VLCOP) 206, a video pre-processing and post-processing (VPP) accelerator 208, a transformation and quantization (TQ) accelerator 210, a motion estimating (ME) accelerator 212, an on-chip memory (OCM) 214, an external memory interface (EMI) 216, a display interface (DSPI) 218, and a camera interface (CAMI) 242. The EMI 216, the DSPI 218, and the CAMI 220 may be utilized within the microprocessor architecture 200 to access the external memory 238, the display 240, and the camera 242, respectively.

The CPU 202 may comprise an instruction port 226, a data port 228, a peripheral device port 222, a coprocessor port 224, tightly coupled memory (TCM) 204, and a direct memory access (DMA) module 230. The instruction port 226 and the data port 228 may be utilized by the CPU 202 to, for example, communicate data processing commands and data via connections to the system bus 244 during decoding of video information.

The TCM 204 may be utilized within the microprocessor architecture 200 for storage and access to large amounts of data without compromising operating efficiency of the CPU 202. The DMA module 230 may be utilized in connection with the TCM 204 to transfer data from/to the TCM 204 during operating cycles when the CPU 202 is not accessing the TCM 204.

The CPU 202 may utilize the coprocessor port 224 to communicate with the VLCOP 206. The VLCOP 206 may be adapted to assist the CPU 202 by offloading certain variable length coding (VLC) decoding tasks. For example, the VLCOP 206 may be adapted to utilize techniques, such as code table look-up and/or packing/unpacking of an elementary bitstream, to work with CPU 202 on a cycle-by-cycle basis. In one aspect of the invention, the VLCOP 206 may comprise a table look-up (TLU) module with a plurality of on-chip memories, such as RAM, and may be adapted to store entries from one or more VLC definition tables. For example, an on-chip memory may be utilized by the VLCOP 206 to store a VLC code entry and another on-chip memory may be utilized to store corresponding description attributes the code may represent. In addition, a bitstream handler (BSH) module may also be utilized within the VLCOP 206 to manage extraction of bits from the encoded bitstream during decoding. In another aspect of the invention, the TLU module within the coprocessor may be adapted to store VLC code entries and corresponding description attributes from a plurality of VLC definition tables. Accordingly, each VLC code entry and/or description attributes entry may comprise a VLC definition table identifier.

The OCM 214 may be utilized within the microprocessor architecture 200 during pre-processing of video data during decompression. For example, the OCM 214 may be adapted to store YUV-formatted data prior to conversion to RGB-formatted data and subsequent communication of such data to the video display 240 via the DSPI 218 for displaying.

In an exemplary aspect of the invention, the OCM 214 may comprise one or more frame buffers that may be adapted to store one or more reference frames utilized during decoding. In addition, the OCM 214 may comprise buffers adapted to store computational results and/or video data after decoding and prior to output for displaying, such as DCT coefficients and/or prediction error information. The OCM 214 may be accessed by the CPU 202, the VPP accelerator 208, the TQ accelerator 218, the ME accelerator 212, the EMI 216, the DSPI 218, and/or the CAMI 220 via the system bus 244.

The CPU 202 may utilize the peripheral device port 222 to communicate with the on-chip accelerators VPP 208, TQ 210, and/or ME 212. The VPP accelerator 208 may comprise suitable circuitry and/or logic and may be adapted to provide video data post-processing during decoding within the microprocessor architecture 200. The VPP accelerator 208 may be adapted to convert decoded YUV-formatted video data to RGB-formatted video data prior to communicating the data to a video display. Post-processed video data from the VPP accelerator 208 may be stored in a local line buffer, for example, of the VPP accelerator 208. Post-processed video data in a VPP local line buffer may be in a QCIF format and may be communicated to, or fetched by, the DSPI 218 and subsequently to the display 240 for displaying. In a different aspect of the invention, the CPU 202 may perform post-processing of video data and post-processed data may be stored in the TCM 204 for subsequent communication to the DSPI 218 via the bus 244.

The TQ accelerator 210 may comprise suitable circuitry and/or logic and may be adapted to perform discrete cosine transformation and quantization related processing of video data, including inverse discrete cosine transformation and inverse quantization. The ME accelerator 212 may comprise suitable circuitry and/or logic and may be adapted to perform motion estimation, motion separation, and/or motion compensation during decoding of video data within the microprocessor architecture 200. By utilizing the VLCOP 206, the VPP accelerator 208, the TQ accelerator 210, the ME accelerator 212, and the OCM 214 during decoding of video data, the CPU 202 may be alleviated from executing computation-intensive tasks associated with the decoding of video data.

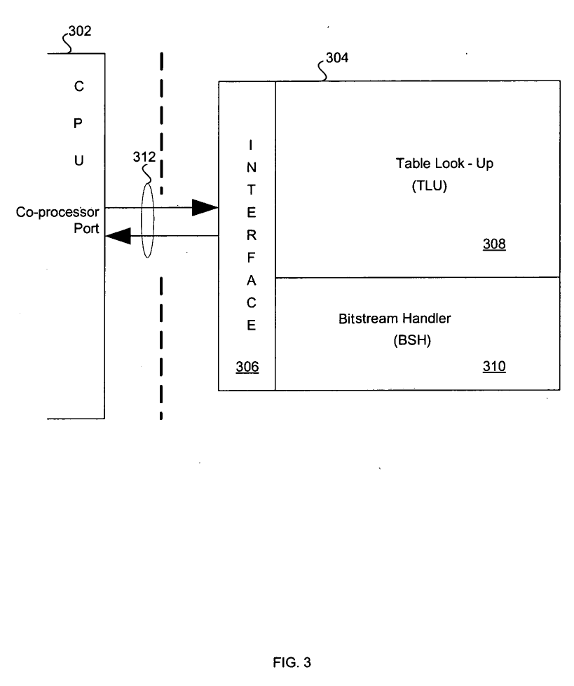

FIG. 3 is a block diagram of an exemplary coprocessor for variable length code (VLC) processing, in accordance with an embodiment of the invention. Referring to FIG. 3, the coprocessor 304 may comprise a CPU interface 306, a table look-up (TLU) module 308, and a bitstream handler (BSH) module 310. The CPU interface 302 may comprise suitable circuitry, logic, and/or code and may be adapted to receive information from, and/or communicate information between the CPU 302 from the TLU module 308 and the BSH module 310 via the connection with the CPU coprocessor port 312. The TLU module 308 and the BSH module 310 may be implemented as tightly coupled extensions of the CPU 302.

In one aspect of the invention, the CPU 302 within a video processing system may utilize the coprocessor 304 on a cycle-by-cycle basis to accelerate the decoding of video information utilizing VLC, for example. The TLU module 308 may comprise one or more on-chip memories, such as RAM, and may be adapted to store one or more entries from a VLC decoding table. For example, an on-chip memory within the TLU module may be utilized to store a VLC code entry and another on-chip memory may be utilized to store a corresponding description entry, such as a LAST, RUN, and LEVEL entry. The BSH module 310 may be utilized within the coprocessor 304 to manage extraction of one or more bits from the encoded bitstream during decoding. In another aspect of the invention, the TLU module 308 within the coprocessor 304 may be adapted to store VLC code entries and corresponding description entries from a plurality of VLC definition tables. Accordingly, each VLC code entry and/or description entry may comprise a VLC definition table identifier.

In operation, during decoding, encoded bitstream may be communicated from the CPU 302 to the BSH module 310 via the interface 306 and the connection 312. One or more VLC decoding tables may be loaded in the TLU module 308. For example, a first RAM in the TLU module 308 may store the description attributes of a VLC table and another memory may store their corresponding VLC code. To resolve the first VLC code in a fixed number of bits extracted from the received encoded bitstream, the extracted fixed number of bits may be matched against one or more of the VLC codes stored in the TLU module 308. After identifying the VLC code in the TLU module 308 that matches the first portion of the received fixed number of bits, the corresponding description entry may be communicated to the CPU 302 via the interface 306 and the connection 312.

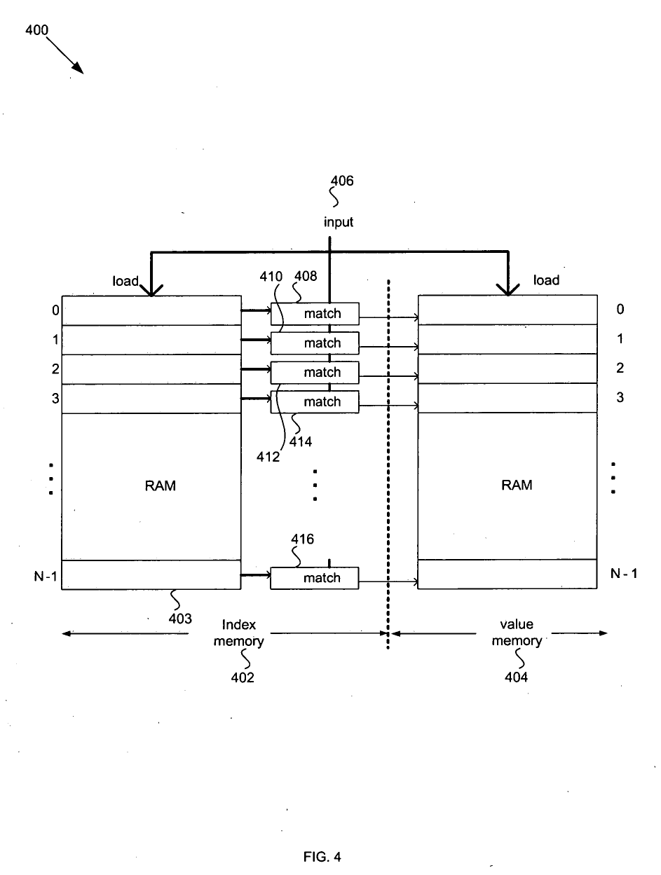

FIG. 4 is a block diagram of a table look-up (TLU) module within a coprocessor for VLC processing, in accordance with an embodiment of the invention. Referring to FIG. 4, the TLU module 400 may comprise an index memory 402 and a value memory 404. The index memory 402 may be implemented as a content addressable memory (CAM) and may comprise a content RAM 403 and matching modules 408 through 416. The content RAM 403 may comprise n number of entries, 0 through (N−1), each corresponding to matching circuitry 408 through 416 and entries 0 through (N−1) in the value memory 404, respectively. Each of the matching modules 408 through 416 may comprise suitable circuitry, logic, and/or code and may be adapted to compare an input entry received via the input signal 406 with a corresponding entry in the content RAM 403. If a match is detected, one or more of the matching modules 408 through 416 that detect the match, may be adapted to select the corresponding entry to output from the value memory 404.

In operation, the content RAM 403 and the value memory 404 may be loaded with VLC definition table entries via the input port 406. For example, the content RAM 403 may be loaded with n number of VLC code entries during decoding of a VLC encoded bitstream. In one aspect of the invention, each content bit in the content RAM 403 may comprise two RAM bits. One RAM bit may be utilized to store content and a second RAM bit may be utilized to store a “don't care” indicator for matching. During look-up and matching by the matching modules 408 through 416, if a “don't care” indicator is asserted, content from the corresponding content bit may be excused from selection in an output signal when the entry is bitwise matched against video information received via the input port 406. Similarly, if a “don't care” indicator is not asserted, content from the corresponding content bit may be bitwise matched against video information received via the input port 406.

Once VLC definition table entries are loaded in the content RAM 403 and the value RAM 404, an input video information received via the input port 406 may be communicated to the matching modules 408 through 416 for matching. During look-up, each of the matching module 408 through 416 may compare bitwise all bits in the input fixed number of bits for processing received via the input port 406 with all content bits in a corresponding content RAM 403 entry. For example, during decoding, fixed number of bits from an encoded bitstream may be communicated to the TLU module 400 for matching by the matching modules 408 through 416 and a corresponding description entry may be outputted from the TLU module 400 to the CPU module, for example.

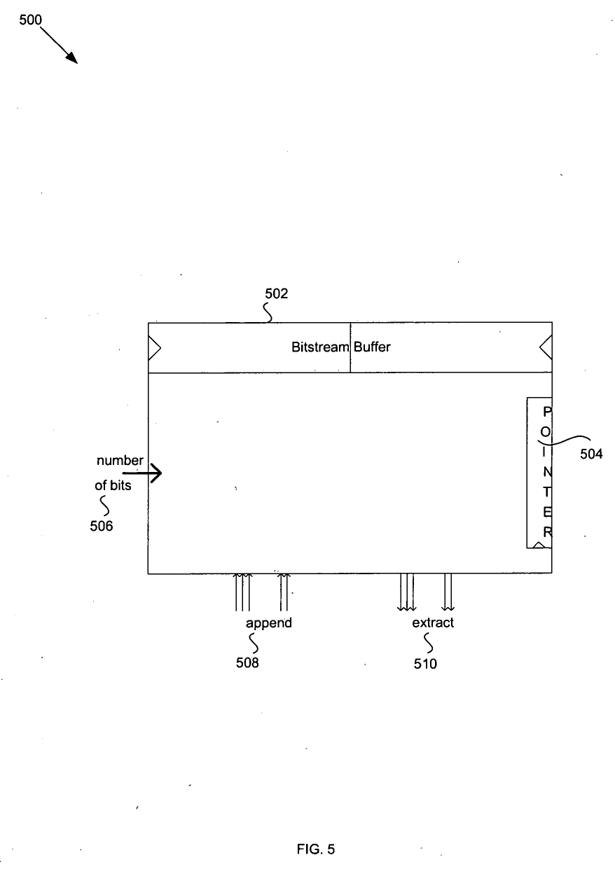

FIG. 5 is a block diagram of a bitstream handler (BSH) module within a coprocessor for VLC processing, in accordance with an embodiment of the invention. Referring to FIG. 5, the BSH module 500 may comprise a bitstream buffer 502 and a pointer 504. The bitstream buffer 502 may be adapted to store an encoded bitstream during encoding and/or decoding. During decoding, a CPU may communicate an encoded bitstream for decoding by a coprocessor's interface module, for example. The communicated bitstream may be stored in the bitstream buffer 502 in the BSH module 500. The CPU may communicate an instruction to the BSH module 500 to extract a fixed number of bits from the current pointer position. The fixed number of bits extracted from the bitstream buffer 502 form a VLC bitstream 510 and is sent to the TLU input port 406 of FIG. 4, for example. After the TLU module matches the first portion of the bitstream with a VLC code entry and locate a corresponding VLC description entry, the TLU module may communicate the corresponding description entry back to the CPU. After communicating the number of bits associated with the matched VLC code entry to the BSH module 500, the BSH module 500 may move the pointer 504 by the corresponding bit number 506 of the extracted VLC code.

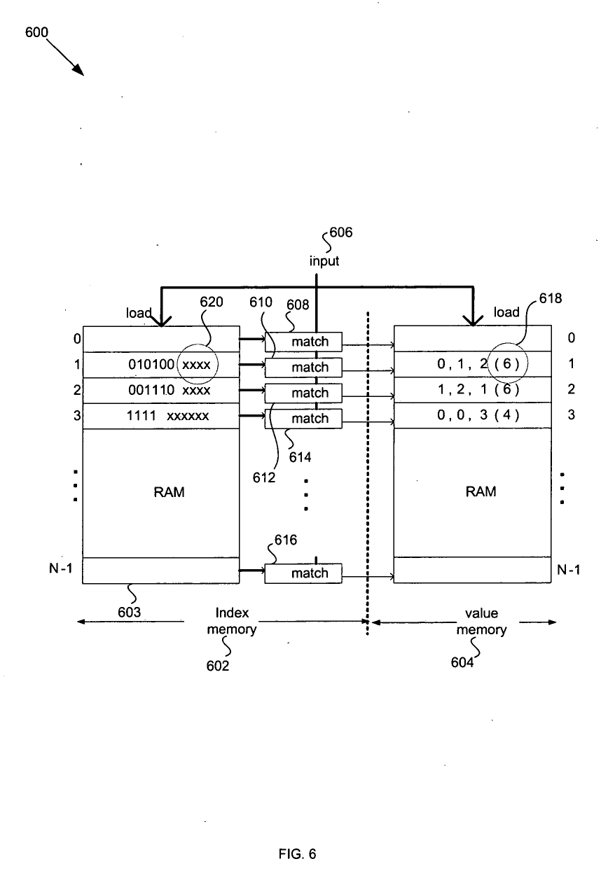

FIG. 6 is a block diagram of a table look-up (TLU) module utilized for VLC decoding, in accordance with an embodiment of the invention. Referring to FIG. 6, the TLU module 600 may comprise an index memory 602 and a value memory 604. The value memory 604 may comprise RAM, for example. The index memory 602 may be implemented as a content addressable memory (CAM) and may comprise a content RAM 603 and matching modules 608 through 616. The content RAM 603 may comprise n number of entries, 0 through (N−1), each corresponding to matching circuitry 608 through 616 and entries 0 through (N−1) in the value RAM 604, respectively. Each of the matching modules 608 through 616 may comprise suitable circuitry, logic, and/or code and may be adapted to compare an input fixed number of bits for processing received via the input port 606 with a corresponding entry in the content RAM 603. If a match is detected, one or more of the matching modules 608 through 616 that detect the match, may be adapted to select a corresponding entry for output from the value memory 604.

In operation, the content RAM 603 and the value RAM 604 may be loaded with VLC definition table entries received via the input port 606. For example, during decoding, the value RAM 604 may be loaded with n number of LAST, RUN, and LEVEL entries and the content RAM 603 may be loaded with a corresponding n number of VLC code entries. In one exemplary embodiment of the invention, each content bit in the content RAM 603 may comprise two RAM bits. One RAM bit may be utilized to store content and a second RAM bit may be utilized to store a “don't care” indicator for matching. During look-up and matching by the matching modules 608 through 616, if a “don't care” indicator is asserted, content from the corresponding content bit may be excused from selection in an output signal when the entry is bitwise compared with the VLC definition table entries received via the input port 606. Similarly, if a “don't care” indicator is not asserted, content from the corresponding content bit may be bitwise matched against the VLC definition table entries received via the input port 606.

In an exemplary embodiment of the invention, each LAST, RUN, and LEVEL entry in the value RAM 604 may comprise a VLC code length indicator 618. The VLC code length indicator 618 may indicate a VLC code length for a corresponding VLC code entry in the content RAM 603. For example, a LAST, RUN, and LEVEL entry of (0, 1, 2) from a VLC encoding table B-16 may be stored in memory entry one in the value RAM 604. A corresponding VLC code “010100” may be stored in memory entry one in the content RAM 603. However, a value “6” may be stored as VLC code length indicator 618 at the end of the LAST, RUN, and LEVEL entry (0, 1, 2) in the value RAM 604, indicating the VLC code length. Further, since each memory block in the content RAM 603 may store a determined number of symbols, after each VLC code entry is stored in the content RAM 603, each VLC code entry may be appended with “don't care” indicators up to the full capacity for each memory block. For example, VLC code “010100” may be stored in a first memory block in the content RAM 603 and may be appended with “don't care” indicators 620 up to the determined capacity of the first memory block.

During decoding, a VLC bitstream may be communicated by a CPU and/or by a BSH module to the TLU module 600 for matching by the matching modules 608 through 616. After a VLC code entry in the content RAM 603 is matched against a first portion of the bitstream received via the input port 606, a corresponding LAST, RUN, and LEVEL entry in the value RAM 604 may be communicated to a CPU for further processing. The VLC code length indicator for each matched VLC code entry may also be communicated to the BSH module so that a pointer within the BSH module may be adjusted according to the VLC code length, since the corresponding VLC code has been identified from the buffered bitstream. After the adjustment of the pointer, the BSH may extract the next bitstream portion for decoding from the bit next to the just identified VLC code in the bitstream buffer.

Once VLC decoding table entries are loaded in the content RAM 603 and the value RAM 604, an input bitstream portion received via the input port 606 may be communicated to the matching modules 608 through 616 for matching. The input bitstream portion may be communicated from a CPU and/or from a BSH module, for example, and may comprise one or more VLC codes for decoding. During look-up, each of the matching modules 608 through 616 may compare the received VLC bitstream bit-pattern with all content bits in a corresponding content RAM 603 entry. If a “don't care” bit within the content RAM 603 is asserted, the corresponding content bit may be ignored. The matching modules 608 through 616 may match the received VLC bitstream with the VLC code entry in the content RAM 603. After a match is located, the corresponding LAST, RUN, and LEVEL entry from the value RAM 604 may be outputted from the TLU module 600 to a CPU, for example. The encoded bitstream may be updated by removing a determined number of bits, corresponding to the identified VLC code entry length, from the bitstream and updating a bitstream buffer pointer.

Even though utilization of one definition table is discussed herein, the present invention may not be so limited. A plurality of definition tables may also be utilized during encoding and/or decoding of video data. For example, MPEG4 video decoding standard defines 20 tables that may be utilized during encoding/decoding. Accordingly, in an exemplary aspect of the invention, a plurality of VLC code entries from multiple tables, during decoding, and/or a plurality of VLC description entries from multiple tables, during encoding, may be stored in a content RAM, where each entry may be preceded by a table indicator.

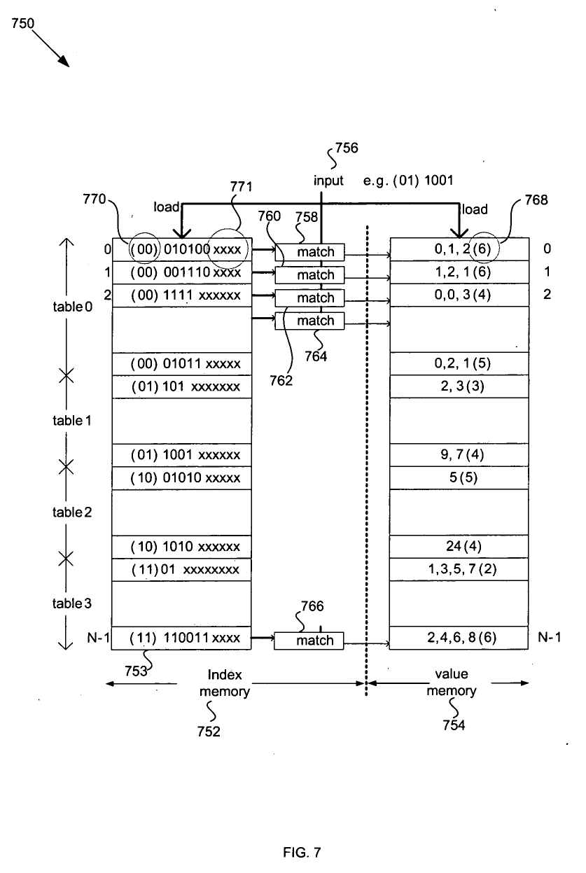

FIG. 7 is a block diagram of a table look-up (TLU) module utilized for VLC decoding with multiple definition tables, in accordance with an embodiment of the invention. Referring to FIG. 7, the TLU module 750 may comprise an index memory 752 and a value memory 754. The value memory 754 may comprise RAM, for example. The index memory 752 may be implemented as a content addressable memory (CAM) and may comprise a content RAM 753 and matching modules 758 through 766. The content RAM 753 may comprise n number of entries, 0 through (N−1), each corresponding to matching circuitry 758 through 766 and entries 0 through (N−1) in the value RAM 754, respectively. Each of the matching modules 758 through 766 may comprise suitable circuitry, logic, and/or code and may be adapted to compare an input bitstream received via the input port 756 with a corresponding entry in the content RAM 753. If a match is detected, one or more of the matching modules 758 through 766, that detect the matching, may be adapted to select a corresponding entry to output from the value RAM 754.

In operation, the content RAM 753 and the value RAM 754 may be loaded with VLC decoding entries from multiple definition tables via the input port 756. For example, during decoding, the value RAM 754 may be loaded with n number of LAST, RUN, and LEVEL attribute entries from multiple definition tables and the content RAM 753 may be loaded with a corresponding n number of VLC code entries from the same multiple definition tables. In one aspect of the invention, each content bit in the content RAM 753 may comprise two RAM bits. One RAM bit may be utilized to store content and a second RAM bit may be utilized to store a “don't care” indicator for matching. During look-up and matching by the matching modules 758 through 766, if a “don't care” indicator is asserted, content from the corresponding content bit may be excused from selection in an output signal when the VLC definition entry is bitwise compared with the bitstream received via the input port 756. Similarly, if a “don't care” indicator is not asserted, or deasserted, content from the corresponding content bit may be bitwise matched against the bitstream portion received via input port 756.

In an exemplary embodiment of the invention, each VLC code entry stored in the content RAM 753 may comprise a definition table indicator, such as table indicator 770. The definition table indicator may be appended by the CPU at the beginning of each VLC code entry that may be received via the input port 756 for storage in the content RAM 753. When an input bitstream is received for decoding, the CPU or BSH may append the corresponding definition table indicator to the input VLC code entry so that the TLU 750 may perform correct matching with VLC code entries from the intended definition table in the content RAM 753.

Each LAST, RUN, and LEVEL entry in the value RAM 754 may comprise a VLC code length indicator 768. The VLC code length indicator 768 may indicate a VLC code length for a corresponding VLC code entry in the content RAM 753. For example, a LAST, RUN, and LEVEL entry of (0, 1, 2) from a first VLC encoding table may be stored in memory entry one in the value RAM 754. A corresponding VLC code “00 010100” may be stored in memory entry one in the content RAM 753, where the first two symbols “00” may be utilized as definition table identifier. A value of “6” may be stored as VLC code length indicator 768 at the end of the LAST, RUN, and LEVEL entry (0, 1, 2) in the value RAM 754, indicating the VLC code length. Further, since each memory block in the content RAM 753 may store a determined number of symbols, after each VLC code entry is stored in the content RAM 753, each VLC code entry may be appended with “don't care” indicators up to the full capacity for each memory block. For example, a first memory block in the content RAM 753 may store VLC code “00 010100,” which may be appended with “don't care” indicators 771 up to the determined capacity of the first memory block.

During decoding, a bitstream may be communicated by a CPU and/or by a BSH module to the TLU module 750 for matching by the matching modules 758 through 766. After a VLC code entry in the content RAM 753 is matched against a first portion in the bitstream from the input port 756, a corresponding LAST, RUN, and LEVEL entry in the value RAM 754 may be communicated to a BSH module and/or a CPU for further processing. In this regard, the value RAM 754 may communicate the matched LAST, RUN, and LEVEL entry to the CPU, and a corresponding VLC code length indicator to the BSH module. The BSH module may utilize the VLC code length indicator so that a corresponding number of bits may be passed from a received encoded bitstream. The VLC code length indicator for each matched VLC code entry may also be communicated to the BSH module so that a pointer within the BSH module may be adjusted according to the VLC code length, so that the next bitstream portion may be extracted from the bit right after the just resolved VLC code in the buffered bitstream.

Once VLC entries from multiple definition tables are loaded in the content RAM 753 and the value RAM 754, a bitstream portion received via the input port 756 may be communicated to the matching modules 758 through 766 for matching. The bitstream portion received via the input port 756 may be communicated from a CPU and/or from a BSH module, for example, and may comprise one or more VLC code entries for decoding. Each communicated bitstream portion may comprise a definition table identifier at the beginning. During look-up, each of the matching modules 758 through 766 may compare the received bitstream bit-pattern with content bits in a corresponding content RAM 753 entry. If a “don't care” bit within the content RAM 753 is asserted, the corresponding content bit may be ignored. The matching modules 758 through 766 may match the received bitstream portion with the VLC code entries in the content RAM 753. After a match is located, the corresponding LAST, RUN, and LEVEL entry from the value RAM 754 may be outputted from the TLU module 750 to a BSH module and/or a CPU, for example. The encoded bitstream may be updated by removing a determined number of bits, corresponding to a decoded VLC code entry length, from the bitstream and updating a bitstream buffer pointer.

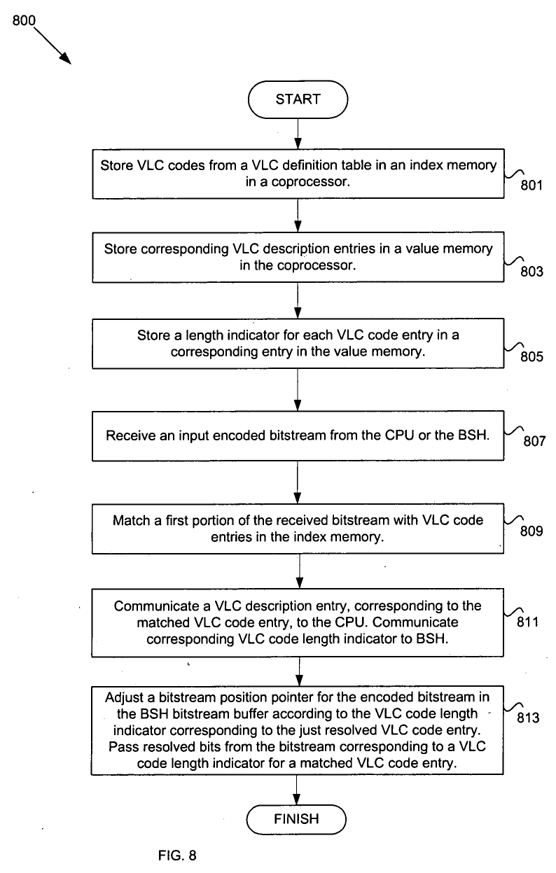

FIG. 8 is a flow diagram of an exemplary method 800 for VLC decoding, in accordance with an embodiment of the invention. Referring to FIG. 8, at 801, VLC codes from a VLC definition table may be stored in an index memory in a coprocessor. At 803, corresponding VLC description entries, which may comprise one or more attributes such as (LAST, RUN, LEVEL), may be stored in a value memory in the coprocessor. At 805, a length indicator for each VLC code entry may be stored in a corresponding entry in the value memory. At 807, an input encoded bitstream may be received from the bitstream handler (BSH) or the CPU. At 809, a first portion of the received bitstream may be matched against a VLC code entry in the index memory. At 811, a VLC description entry, corresponding to the matched VLC code entry, may be communicated to the CPU. A corresponding code length indicator of the VLC entry may be communicated to BSH. At 813, a bitstream position pointer for the encoded bitstream in the BSH bitstream buffer may be adjusted according to the VLC code length indicator corresponding to the just resolved VLC code entry. The resolved bits may then be removed from the bitstream, where the number of removed bits may correspond to a VLC code length indicator of the matched VLC code entry.

Accordingly, aspects of the invention may be realized in hardware, software, firmware or a combination thereof. The invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

Another embodiment of the present invention may be implemented as dedicated circuitry in an ASIC. The dedicated circuitry may work together with a general purpose processor in the ASIC to carry out the data transferring and calculation tasks according to the present invention. The partition of workload between the general purpose processor and the dedicated circuitry may be determined by system performance requirement and/or by cost considerations.

The invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing video data, the method comprising:
receiving an input encoded bitstream to be processed;
matching at least a portion of said received input encoded bitstream against at least a portion of stored indexed variable length code entries having a corresponding video information entry;
if a match is found, removing said matched portion from said input encoded bitstream; and
offloading at least a portion of said matching and said removing to at least one on-chip coprocessor.

2. The method according to claim 1, further comprising storing said indexed variable length code entries in a content addressable memory (CAM).

3. The method according to claim 1, wherein each bit of said at least a portion of said indexed variable length code entries is stored utilizing at least one of a content bit and a “don't care” indicator bit.

4. The method according to claim 3, further comprising matching at least a portion of said received input encoded bitstream to be processed against said at least a portion of said indexed variable length code entries, if at least one “don't care” indicator bit corresponding to said at least a portion of said indexed variable length code entries is not asserted.

5. The method according to claim 1, further comprising, if a match is found, selecting a matched corresponding video information entry based on said matching, wherein said matched corresponding video information entry is an output decoded video information stream represented by said matched portion in the said received input encoded bitstream to be processed.

6. The method according to claim 1, further comprising storing at least one variable length code length indicator for each of said variable length code entries.

7. The method according to claim 1, wherein each of said stored indexed variable length code entries comprises at least one variable length code definition table indication bit, which corresponds to a variable length code definition table.

8. A machine-readable storage having stored thereon, a computer program having at least one code section for processing video data, the at least one code section being executable by a machine to perform steps comprising:
receiving an input encoded bitstream to be processed;
matching at least a portion of said received input encoded bitstream against at least a portion of stored indexed variable length code entries having a corresponding video information entry;
if a match is found, removing said matched portion from said input encoded bitstream; and
offloading at least a portion of said matching and said removing to at least one on-chip coprocessor.

9. The machine-readable storage according to claim 8, further comprising code for storing said indexed variable length code entries in a content addressable memory (CAM).

10. The machine-readable storage according to claim 8, wherein each bit of said at least a portion of said indexed variable length code entries is stored utilizing at least one of a content bit and a “don't care” indicator bit.

11. The machine-readable storage according to claim 10, further comprising code for matching at least a portion of said received input encoded bitstream to be processed against said at least a portion of said indexed variable length code entries, if at least one “don't care” indicator bit corresponding to said at least a portion of said indexed variable length code entries is not asserted.

12. The machine-readable storage according to claim 8, further comprising, if a match is found, code for selecting a matched corresponding video information entry based on said matching, wherein said matched corresponding video information entry is an output decoded video information stream represented by said matched portion in the said received input encoded bitstream to be processed.

13. The machine-readable storage according to claim 8, further comprising code for storing at least one variable length code length indicator for each of said variable length code entries.

14. The machine-readable storage according to claim 8, wherein each of said stored indexed variable length code entries comprises at least one variable length code definition table indication bit, which corresponds to a variable length code definition table.

15. A system for processing video data, the system comprising:
at least one processor that receives an input encoded bitstream to be processed;
said at least one processor and at least one on-chip coprocessor match at least a portion of said received input encoded bitstream against at least a portion of stored indexed variable length code entries having a corresponding video information entry;
if a match is found, said at least one processor removes said matched portion from said input encoded bitstream; and
said at least one processor offloads at least a portion of said matching and said removing to said at least one on-chip coprocessor.

16. The system according to claim 15, wherein said at least one processor stores said indexed variable length code entries in a content addressable memory (CAM).

17. The system according to claim 15, wherein each bit of said at least a portion of said indexed variable length code entries is stored utilizing at least one of a content bit and a “don't care” indicator bit.

18. The system according to claim 17, wherein said at least one processor and said at least one on-chip coprocessor match at least a portion of said received input encoded bitstream to be processed against said at least a portion of said indexed variable length code entries, if at least one “don't care” indicator bit corresponding to said at least a portion of said indexed variable length code entries is not asserted.

19. The system according to claim 15, wherein, if a match is found, said at least one processor selects a matched corresponding video information entry based on said matching, wherein said matched corresponding video information entry is an output decoded video information stream represented by said matched portion in the said received input encoded bitstream to be processed.

20. The system according to claim 15, wherein said at least one processor stores at least one variable length code length indicator for each of said variable length code entries.

21. The system according to claim 20, further comprising a bitstream handler (BSH) module that reduces said received encoded bitstream by at least a portion of said variable length code corresponding to said stored at least one variable length code length indicator.

22. The system according to claim 15, wherein each of said stored indexed variable length code entries comprises at least one variable length code definition table indication bit, which corresponds to a variable length code definition table.
